(19) United States
(12) Patent Application Publication
(10) Pub. No.: US 2025/0247668 A1
(43) Pub. Date: Jul. 31, 2025

(54) Methods and Apparatus for Reducing Network Attachment Delays When Roaming

(71) Applicant: Charter Communications Operating, LLC, St. Louis, MO (US)

(72) Inventor: Saran Khalid, Denver, CO (US)

(21) Appl. No.: 18/423,171

(22) Filed: Jan. 25, 2024

(51) Int. Cl. H04W 4/021; H04W 4/12; H04W 76/10; H04W 88/06

(52) U.S. Cl. CPC H04W 4/021; H04W 4/12; H04W 76/10; H04W 88/06

(57) ABSTRACT

A communications device, e.g., UE, detects a text message or email indicating planned travel to a destination. The communications device determines, either directly or indirectly, the travel destination from text included in the detected text message or email. The communications device retrieves, e.g. via sending a request to its core network and receiving a response from the core network, roaming partner network information corresponding to the first destination. The communications devices loads, e.g. prior to departure, a portion of memory in the communications device, e.g., memory in its eSIM, with the received roaming partner network information. When the communications device arrives at the travel destination, the communications device is able to rapidly and efficiently establish a connection with a roaming partner access network providing wireless coverage at the destination by using the pre-loaded roaming partner network information.

### FIELD

The invention is directed to methods and apparatus for improving a user's experience and more particularly to methods and/or apparatus for reducing network attachment delays when roaming, e.g., in accordance with travel plans.

### BACKGROUND

Mobile operators usually operate within certain geographical limits such as country, county or state boundaries. Mobile subscribers often travel outside these boundaries.

Mobile operators provide ‘roaming’ to these travelers via roaming agreements to allow connectivity outside the operating region of the mobile operator. This allows mobile operators to continue the mobile communication without disruption or having to change the mobile Subscriber Identity Module (SIM).

When a user equipment (UE) moves out of a network operator's region and enters another network operator's region, the UE will continue to scan for various channels to connect to the wireless network. However, since the UE (mobile) doesn't have prior knowledge of which channel to scan, it may take several minutes before the UE is connected to a new operator.

Based on the above, there is a need for new methods and apparatus to facilitate efficient and rapid UE re-connect when a subscriber using a UE in a first coverage area corresponding to first operator moves to a new coverage area corresponding to a different operator.

### SUMMARY

Methods and apparatus, in accordance with the present invention, make use of available information such as a destination of a flight, corresponding to a UE subscriber, to identify an expected future location of the subscriber's UE. In some embodiments, the UE monitors for and detects a text message or e-mail, e.g., sourced from an airline or travel booking service, which communicates a flight number, e.g. corresponding to a flight booking confirmation. Based on information, e.g., the flight number or the destination location, included in the detected received text message or e-mail, the UE determines the flight destination and expected arrival date and time, either directly, via information included in the text message or e-mail, or indirectly, e.g., via accessing an airline/generic flight database. The UE subsequently requests, e.g., from its core network, for network information corresponding to one or more roaming partner access networks, which can provide wireless communications services to the UE at the destination. The UE receives a response from the core network to its request, said response including roaming partner network information corresponding to one or more roaming partner access networks. In some embodiments, the response includes a prioritized list indicating particular access network(s), particular frequency band(s), and/or particular frequency channel(s) for scanning at the destination by the UE, when trying to obtain a wireless connection with a RAN. The received determined information for scan, corresponding to the new location (flight destination), is loaded into the UE before arrival at the new location (flight destination location). In some embodiments the determined information for an efficient scan is loaded into the UE, e.g., into an e-SIM in the UE, prior to departure. In this way, the UE (mobile) can start looking for the correct channel right away instead of having to scan the entire spectrum. This approach facilitates a more efficient and faster re-connect when a subscriber is in a new location.

An exemplary method of operating a communications device, e.g. user equipment device (UE), in accordance with some embodiments, comprises: detecting a text or email indicating planned travel to a first destination; determining a travel destination from text included in the detected text or email, said travel destination being the first destination; retrieving roaming partner network information corresponding to the first destination; and loading a portion of memory in the communications device with the roaming partner network information.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing illustrating a UE roaming regionally.

FIG. 2 is a drawing illustrating exemplary information flow and steps to prepare an exemplary UE to roam in accordance with an exemplary embodiment.

FIG. 3 is a drawing illustrating an exemplary 3GPP 5G network architecture in accordance with an exemplary embodiment.

FIG. 4 includes a table illustrating exemplary spectrum holdings corresponding to different mobile network operators and/or to different geographical regions.

FIG. 5 is a drawing of a signaling diagram illustrating exemplary operations and exemplary messages for an exemplary embodiment.

FIG. 6A is a first part of a flowchart of an exemplary method of operating a communications device, e.g., a user equipment (UE), in accordance with an exemplary embodiment.

FIG. 6B is a second part of a flowchart of an exemplary method of operating a communications device, e.g., a user equipment (UE). in accordance with an exemplary embodiment.

FIG. 6 comprises the combination of FIG. 6A and FIG. 6B.

FIG. 7 is a drawing of an exemplary user equipment (UE) in accordance with an exemplary embodiment.

FIG. 8 is a drawing of an exemplary policy control function (PCF) device, e.g. a 5G core network node implementing a PCF, in accordance with an exemplary embodiment.

FIG. 9 is a drawing of an exemplary airline(s)/travel booking texting/email service server.

FIG. 10 is a drawing of an exemplary roaming partner database.

FIG. 11 is a drawing of an exemplary band/channel database, e.g., an International Telecommunication Union (ITU)/common database band/channel database or a mobile network operator (MNO) band/channel database.

FIG. 12 is a drawing of an exemplary radio access network (RAN) node, e.g. base station, e.g., a gNB, in accordance with an exemplary embodiment.

FIG. 13 is a drawing of an exemplary airline/generic flight database server.

FIG. 14 is a drawing of an exemplary communications system in accordance with an exemplary embodiment.

### DETAILED DESCRIPTION

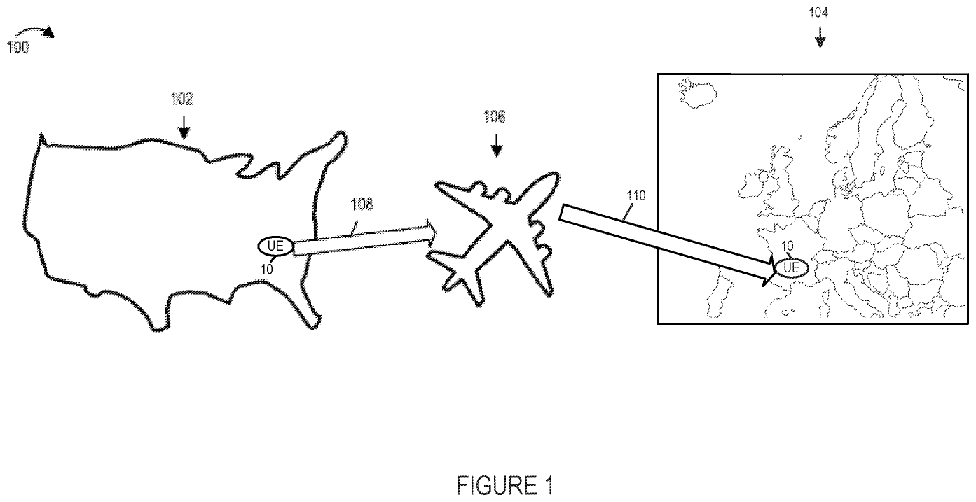

FIG. 1 is a drawing 100 illustrating an exemplary UE 10 roaming regionally. Consider a passenger, who is a subscriber to a particular mobile network operator in the US, who has a UE 10, and who is planning on flying on a plane 106 on a flight, from a departure location within the continental United States of America (USA) 102 to a destination location in a country, e.g., France, in Europe 110. Arrows 108, 110 illustrate an exemplary flight path of the exemplary flight. For each such flight there is an associated flight number and time of departure. A sample of this information would be:
Flight: UA2395
Departure time: 9.50 PM

This information is available in various forms such as text, mobile application and email etc. i.e., when a passenger books a flight, this information is sent to the passenger. This information is useful in determining the destination and preparing for the UE for roaming in advance.

An exemplary process of acquiring this information will now be described. A program function, e.g., an application (APP), within the mobile (UE), will look for texts, e.g., text messages sent from airlines. There is usually a limited number of phone numbers, within a country, that correspond to airlines, which have out of country flight operations, and those phone numbers can be monitored for incoming text messages. In some embodiments, the program function, e.g., application (APP), within the mobile (UE), will also look for e-mail messages, e.g., sent from airlines. There are a limited number of e-mail addresses, within a country, that correspond to airlines, which have out of country flight operations, and those e-mail addresses can be monitored, e.g., for incoming e-mails.

The program function, e.g., APP, built within the mobile operating system on the mobile or within an application installed on the mobile, can, and in some embodiments does, also ask the user to confirm a departure.

The program function will then read the text (in the detected text message or detected e-mail) and if it finds a flight number, it will note down and store the flight number and departure time.

The program function, e.g., APP, will use the flight number and look up the itinerary of the flight and determine the destination(s).

With the destination determined, now the mobile network has to provide the details of the roaming partners i.e., which roaming partner is preferred in that part of the country/region. This can be, and in some embodiments is, obtained directly from a table sitting on a database of a policy control function (PCF). In addition to the PCF, the details of the roaming partners, i.e., which roaming partner is preferred in that part of the country/region can also be, in some embodiments, obtained from a web page, which can be updated as roaming agreements are updated. This is once again, in the form of a table that could be queried to determine which region has which roaming partner.

Once the roaming partner operator, at the destination, is known, a quick query to International Telecommunications Union Radiocommunication Sector's (ITU-R's) database or a simple database holding this information could be queried that lists out all the spectrum and license.

This information about channels, corresponding to the roaming partner at the destination, will be internally saved in the mobile and scheduled to be pushed to the mobile cache which will later be either pushed to eSIM or will be used in combination with eSIM to locate the correct operator and the channels.

Therefore, instead of scanning the entire spectrum, the mobile will look for a particular operator, e.g., the identified preferred partner operator at the destination, and its bands at the destination.

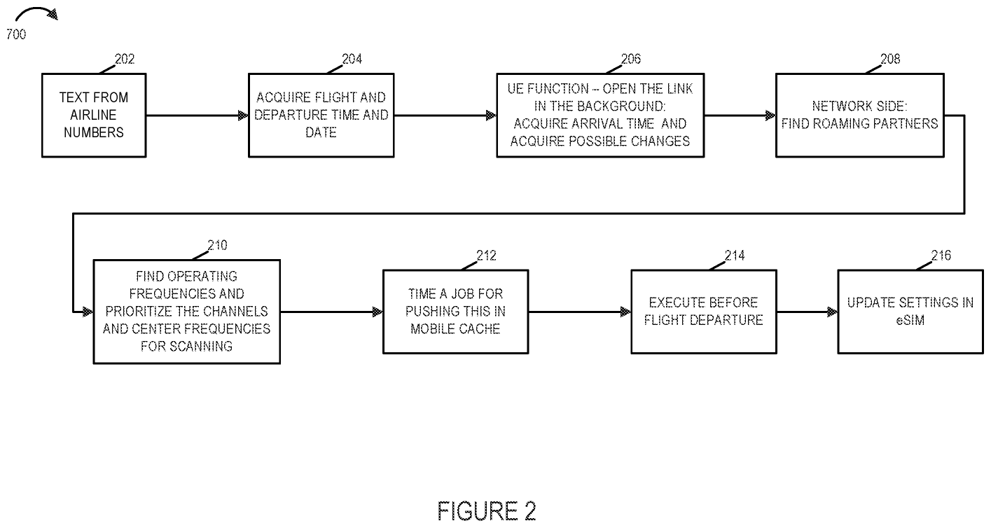

FIG. 2 is a drawing 200 illustrating exemplary information flow and steps to prepare an exemplary UE to roam in accordance with an exemplary embodiment. In step 202 text from airline numbers is processed by the UE, e.g., an application, sometime referred to as a function, on the UE determines that a received text message or a received e-mail has come from a number corresponding to an airline or from an e-mail address corresponding to an airline, e.g., based on a comparison of a list of numbers associated with airlines and/or flight booking services and/or a comparison of a list of e-mail addresses corresponding to airlines and/or flight booking services. The application in the UE searches the text of the received text message or received e-mail for flight information, e.g. flight booking confirmation information. In step 204, as a result of the search of text of the received text message or received e-mail, the application on the UE acquires information identifying a flight, e.g., a flight number, a departure date, and a departure time for the flight.

In step 206 the UE application opens a link in background and acquires an arrival time for the flight and acquires possible changes, e.g., an update regarding the flight due to delays, e.g., from database of flights being maintained by the airline corresponding to the flight or by a generic flight database, e.g., including information about flights corresponding to the departure airport and/or the destination airport. For example, the UE application sends a database query to an airline/generic flight database, said query identifying a particular flight, e.g. by flight number, and requesting an arrival time and destination for the flight, and in response the flight database sends the UE application the arrival time and destination, e.g., information identifying the destination city/country airport, for the flight.

In step 208 the UE application contacts the communications network side, e.g., its 5G core network, to find roaming partners, at the flight destination, of the operator to which the UE user subscribes. For example, the UE application sends a roaming partner information request, e.g., including information identifying the destination or region, e.g., destination country and/or specific area within the destination country, corresponding to the destination, to the policy control function (PCF) in a 5G core of the operator network of the UE or to a roaming partner database. The PCF or the roaming partner database determines the preferred roaming partner(s) at the destination. In some embodiments, the roaming partner database is included with the 5C core, e.g., as part of the PCF. In other embodiments, the roaming partner database is external to the PCF, but is accessible to the PCF.

In step 210 the PCF or roaming partner database finds operating frequencies and prioritizes the channels and center frequencies for scanning. For example, the PCF sends a channel request to a band/channel database, e.g., an ITU/common universal database or a band/channel database of the identified roaming partner operator(s), and the band/channel database retrieves and sends corresponding roaming partner network(s) information including channel information to the PCF. A function within the PCF prioritizes the various alternative available roaming partner network(s), frequency bands, and/or the various channels, and based on native networks configuration, the PCF determines a list of channels to scan, e.g., an ordered search list to be used by the UE at the location. The PCF sends the channel information indicating, e.g., operating frequencies, e.g., bands, in use by the roaming partner operator(s) at the destination, prioritized channels and corresponding center frequencies for scanning by the UE at the destination. The UE receives roaming partner network information including channel information and stores the information in the UE, said information to be pushed into the eSIM of the UE, e.g., as part of an upgrade, prior to arrival at the destination, e.g. in some embodiments, prior to departure. In step 212 the UE application times a job for pushing this channel search information corresponding to the roaming partner operator(s) at the flight destination, e.g., which is being stored in UE cache, into the eSIM, e.g., the UE determines a time to execute the eSIM update before arrival at destination. In some embodiments, the eSIM update time is determined to be a time before flight departure. In step 214, the UE application determines that the time for the eSIM update has been reached and states executing the update, e.g., before flight departure. In step 216 the UE application completes the update of settings in the eSIM, e.g., roaming partner network information has been loaded into the eSIM to facilitate rapid and efficient connection establishment with a preferred roaming partner network when the UE arrives at the flight destination.

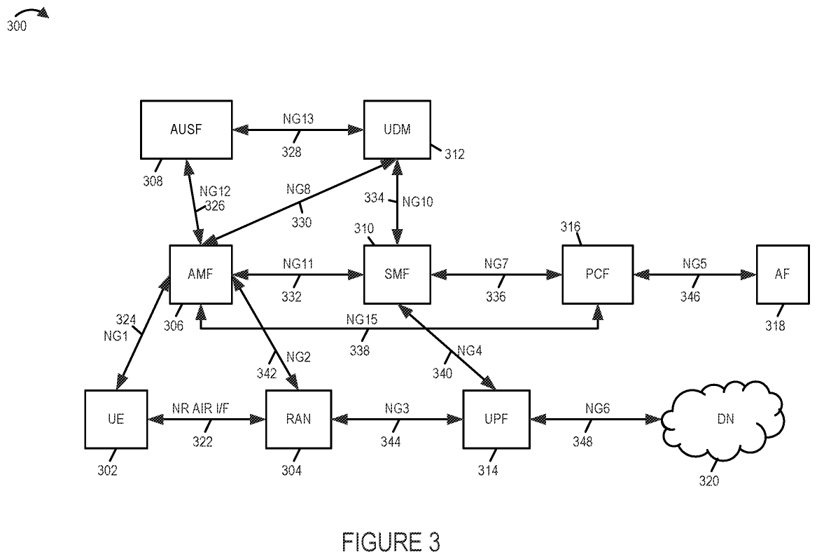

FIG. 3 is drawing illustrating exemplary 3GPP 5G network architecture 300 in accordance with an exemplary embodiment. Exemplary 5GPP 5G network architecture 300 includes user equipment (UE) 302, a radio access network (RAN) 304, a plurality of core network functions, and a data network (DN) 320 coupled together as shown. The plurality of core network functions includes an access and mobility management function (AMF) 306, an authentication server function (AUSF) 308, a session management function (SMF) 310, a unified data management (UDM) 312, a policy control function (PCF) 316, a user plane function (UPF) 314, and application function (AF) 318. UE 302 is coupled to RAN 304 via NR (new radio) air interface (I/F) 322. UE 302 is coupled to AMF 306 via NG1 interface connection 324. AMF 306 is coupled to AUSF 308 via NG 12 interface connection 326. AUSF 308 is coupled to UDM 312 via NG 13 interface connection 328. AMF 306 is coupled to UDM 312 via NG8 interface connection 330. AMF 306 is coupled to SMF 310 via NG11 interface connection 332. SMF 310 is coupled to UDM 312 via NG10 interface connection 334. SMF 310 is coupled to PCF 316 via NG7 interface connection 336. AMF 306 is coupled to PCF 316 via NG15 interface connection 338. SMF 310 is coupled to UPF 314 via NG4 interface connection 340. AMF 306 is coupled to RAN 304 via NG2 interface connection 342. RAN 304 is coupled to UPF 314 via NG3 interface connection 344. PCF 316 is coupled to application function (AF) 318 via NG5 interface connection 346. UPF 314 is coupled to DN 320 via NG6 interface connection 348.

In accordance with a feature of various exemplary embodiments, the PCF 316 receives a roaming partners information request from UE 302, corresponding to a destination, e.g., a flight destination, and returns roaming partner network information including channel information for the UE, said returned roaming partner network information including channel information to be used to update the UE 302, e.g. update an eSIM in the UE, in advance to arrival at the destination, said received roaming partner network information including channel information including information identifying spectrum (e.g., particular bands) used by the roaming partner at the destination, particular channels used by the roaming partner operator at the destination along with center frequency information, and channel priority information. The upgrade of the UE 302 eSIM, prior to arrival at the destination, allows to the UE 302 to quickly start an efficient search to establish a connection with a preferred identified roaming partner operator network at the destination.

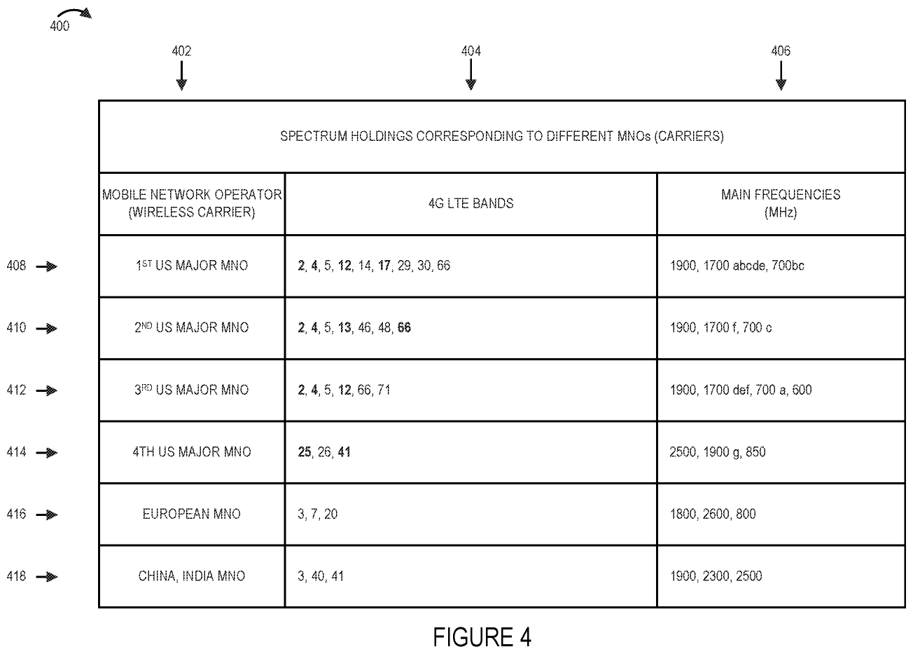

FIG. 4 includes a table 400 illustrating exemplary spectrum holdings corresponding to different mobile network operators (MNOs), sometimes referred to as wireless carriers, and/or to different geographical regions. First column 402 includes information identifying the MNO, second column 404 identifies the 4G LTE bands, and third column 406 identifies the main frequencies. Row 408 indicates that a 1st US major MNO has spectrum holdings in the following 4G LTE bands: 2, 4, 5, 12, 14, 17, 29, 30 and 66, and the main frequencies are 1900 MHZ, 1700 MHz abcde, and 700 MHZ bc. Row 410 indicates that a 2nd US major MNO has spectrum holdings in the following 4G LTE bands: 2, 4, 5, 13, 46, 48, and 66, and the main frequencies are 1900 MHz, 1700 MHz f, and 700 MHz c. Row 412 indicates that a 3rd US major MNO has spectrum holdings in the following 4G LTE bands: 2, 4, 5, 12, 66 and 71, and the main frequencies are 1900 MHZ, 1700 MHz def, and 700 MHz a, and 600 MHz. Row 414 indicates that a 4th US major MNO has spectrum holdings in the following 4G LTE bands: 25, 26, and 41, and the main frequencies are 2500 MHZ, 1700 MHz def, and 1900 MHz g, 850 MHz. Row 416 indicates that a European MNO has spectrum holdings in the following 4G LTE bands: 3, 7, and 20, and the main frequencies are 1800 MHZ, 2600 MHZ, and 800 MHz. Row 419 indicates that a China or India MNO has spectrum holdings in the following 4G LTE bands: 3, 40, and 41, and the main frequencies are 1900 MHZ, 2300 MHZ, and 2500 MHz.

Different 4G LTE band spectrum holdings corresponding to an individual MNO (e.g., 1st US major MNO) may, and sometimes do, correspond to different geographic regions. Mappings for an MNO (wireless carrier) correlating its individual spectrum holdings, in its set of spectrum holding, to geographic regions in which the MNO provides wireless coverage via its access networks is stored in a database.

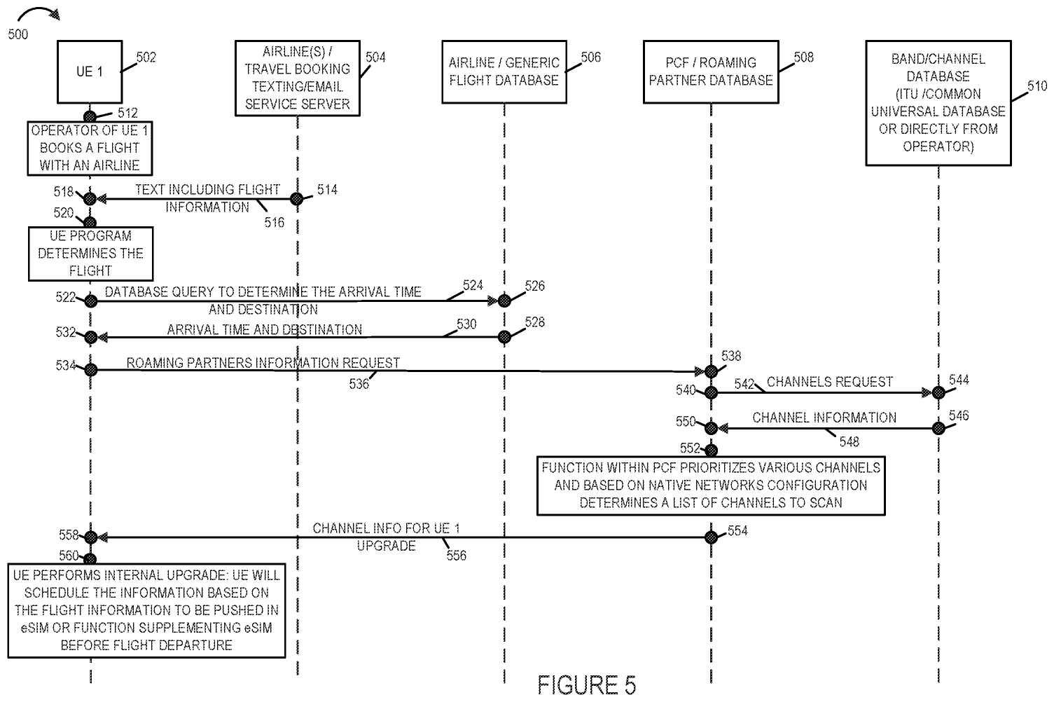

FIG. 5 is a drawing of a signaling diagram 500 illustrating exemplary operations and exemplary messages for an exemplary method of reducing network attachment delays when roaming, e.g., in accordance with travel plans. Signaling diagram 500 includes UE 1 502, airline(s) texting/e-mail service server 504, airline/generic flight database 506, PCF/roaming partner database 508 and band/channel database 510, e.g., an ITU/common universal database or a database directly from an operator (e.g., a particular MNO band/channel database corresponding to an identified roaming partner network providing wireless coverage at the destination).

In step 512, the operator (user/owner) of UE 1 502 books a flight, e.g., an international flight, with an airline, e.g., via UE 1 502. In step 514, airline(s) texting/e-mail service server 504 generates and sends text 516 (as part of a text message or e-mail message), e.g. a flight booking confirmation text or e-mail, including flight information, e.g., a flight number, a departure date and a departure time, to UE 1 502. In step 518 UE 1 502 receives the text 516 including the received text message or received e-mail. In step 520, an application on the UE 502, which is monitoring to identify text messages and/or e-mail messages from airlines and/or airline booking services, e.g., based on comparing source phone numbers and/or source e-mail addresses to a predetermined list of phone numbers and/or a predetermined list of e-mail addresses associated with airlines and/or airline booking services, determines, e.g., based on a phone number match or an e-mail address match, that the received text 516 in the received text message or received w-mail was sent from a number or e-mail address corresponding to an airline or an airline booking service. Then, as part of step 520, the application in UE 1 502 scans the received text message or received e-mail 516 to determine the flight, e.g., the application in the UE identifies the flight number associated with the flight, the planned departure date for the flight and the planned departure time for the flight.

In step 522 the UE 1 502 generates and sends a database query 524 to an airline or generic flight database 506 to determine the arrival time and destination of the flight. The database query 524 includes the flight number and may, and sometimes does, include the departure data/time information. In step 526, the airline/generic flight database 506 receives the database query 524, and in response, the flight database 506 retrieves the requested information. In step 528 the flight database 506 generates and sends a response message 530 to the UE 1 502, said response message 530 including the arrival time and the destination associated with the flight. In step 532 UE 1 502 receives response message 530 and recovers the communicated information, e.g. arrival time and destination.

In step 534 UE1 502 generates and sends a roaming partners information request 536 to PCF/roaming partner database 508. In some embodiments, the roaming partner database is included as part of the PCF, while in other embodiments, the roaming partner database is separate from the PCF but accessible to the PCF. The roaming partners information request 536 includes information identifying the destination. In step 508 the PCF/roaming partner database 508 receives the roaming partners information request 536 and identifies, from information stored in the roaming partners database, one or more roaming partner networks which have access networks providing wireless coverage at the destination location. In some embodiments, the PCF selects, a preferred roaming partner from among multiple possible alternative roaming partners, e.g., a preferred roaming partner from the perspective of the mobile network operator (MNO) to which the user of UE 1 502 is a subscriber, at the flight destination. The network operator to which UE1 502 is a subscriber device may have different preferred roaming partners in different countries and/or different portions of a country, e.g., in accordance with roaming partnership agreements between operators. In some embodiments, selecting a roaming partner operator(s) to be used by UE 1 502 at the destination further includes taking into consideration the capabilities of UE 1 502, e.g., which technologies, protocols, and communications bands are supported by UE 1 502 and which technologies, protocols, and communications bands are in use at the destination by different possible partner operators.

In step 540 the PCF 508 generates and sends a channels request message 542 to the band/channel database 510, said channels request identifying the destination location of interest. In step 544, the band/channel database 510 receives the channels request 542, said channels request including information identifying the destination or information identifying a region, e.g., a wireless coverage region, in which the destination is located. In some embodiments, e.g., an embodiment in which the request 542 is sent to a common universal database, the request 542 further includes information identifying one or more roaming partner operators of interest. In step 544 the band/channel database 510 receives the channels request 542, and in response, in step 546 the band/channel database 510 generates and sends channel information response message 548 to PCF 508, said response message 548 including: i) information identifying one or more frequency bands being used by the roaming partner at the destination, ii) information identifying one or more channels being used by the roaming partner at the destination for each of the identified one or more frequency bands, iii) information identifying a frequency, e.g., carrier frequency associated with each identified channel, and iv) channel priority information, e.g. information identifying a search order of identified channels. In some embodiments, the channels request 542 including information identifying more than one roaming partner network operators, e.g. multiple alternative roaming partner network operators and the response message 548 including roaming partner network information corresponding to each of the identified roaming partner network operators in the request. In step 550 PCF 508 receives response message 548 and recovers the communicated channel information.

In step 552 a function, e.g., application, within the PCF 508 prioritizes various possible alternative roaming partner networks, alternative bands, and/or alternative channels and based on native network configuration determines a list of channels to scan. In step 554 the PCF generates and sends a message 556 to UE 1 502, said message 556 including roaming partner network information including channel information for a UE 1 upgrade (update). In step 558 UE 1 502 receives message 556 and recovers the channel information for the UE 1 upgrade. In step 560 UE 502 performs an internal upgrade. UE1 502 schedules the channel upgrade information, based on the flight information, to be pushed in eSIM or a function supplementing eSIM before flight departure.

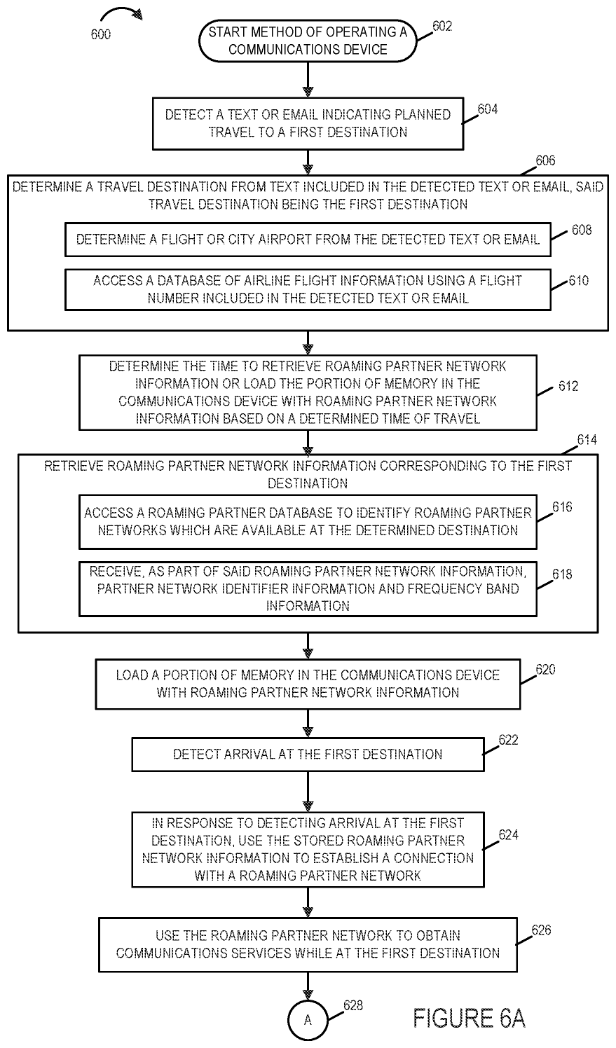

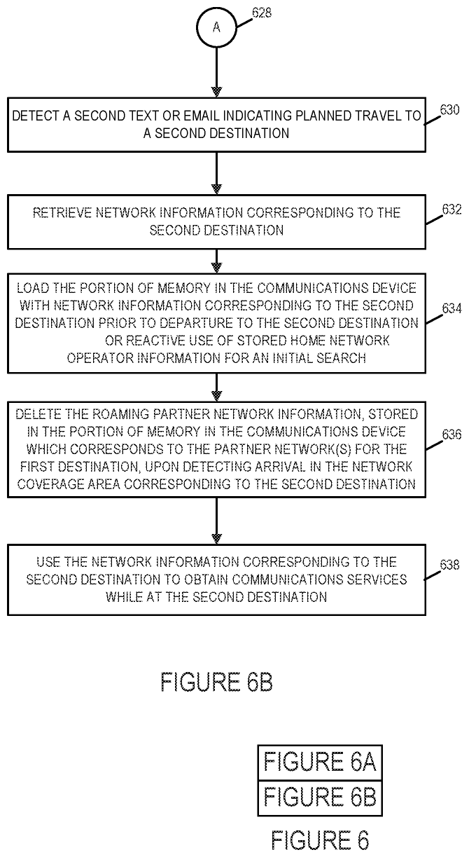

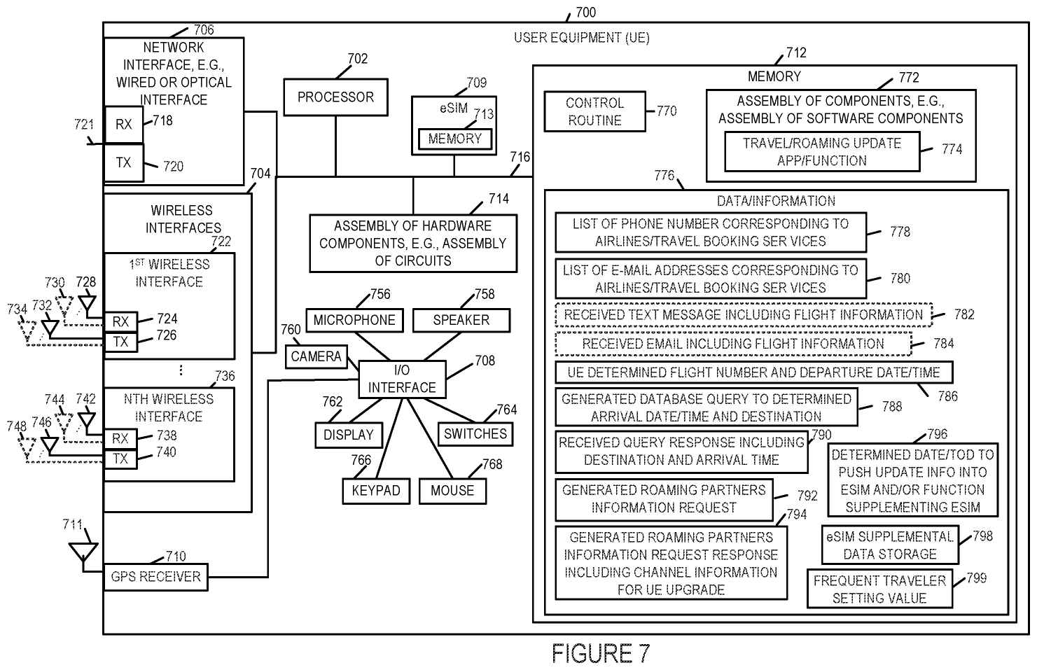

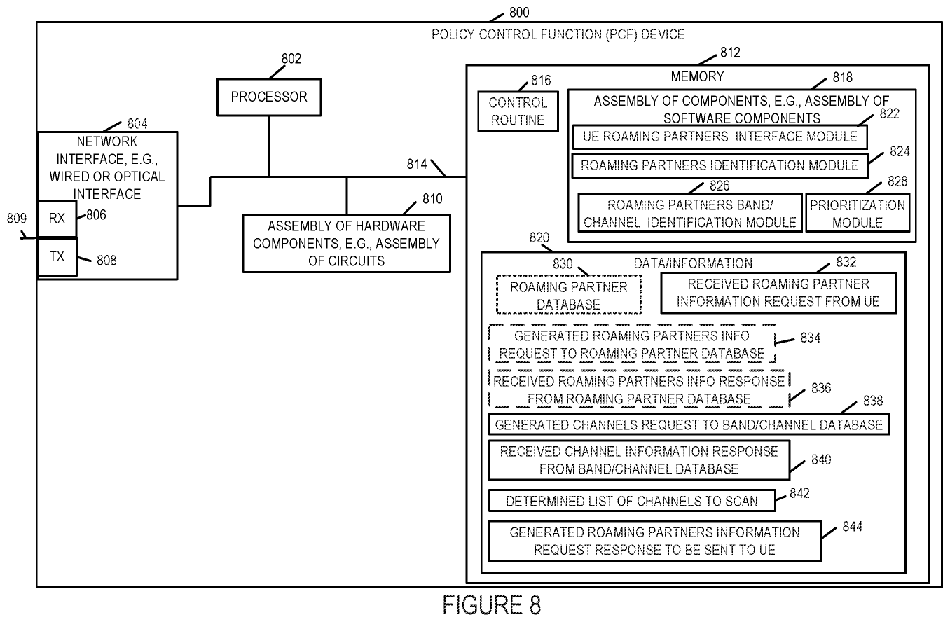

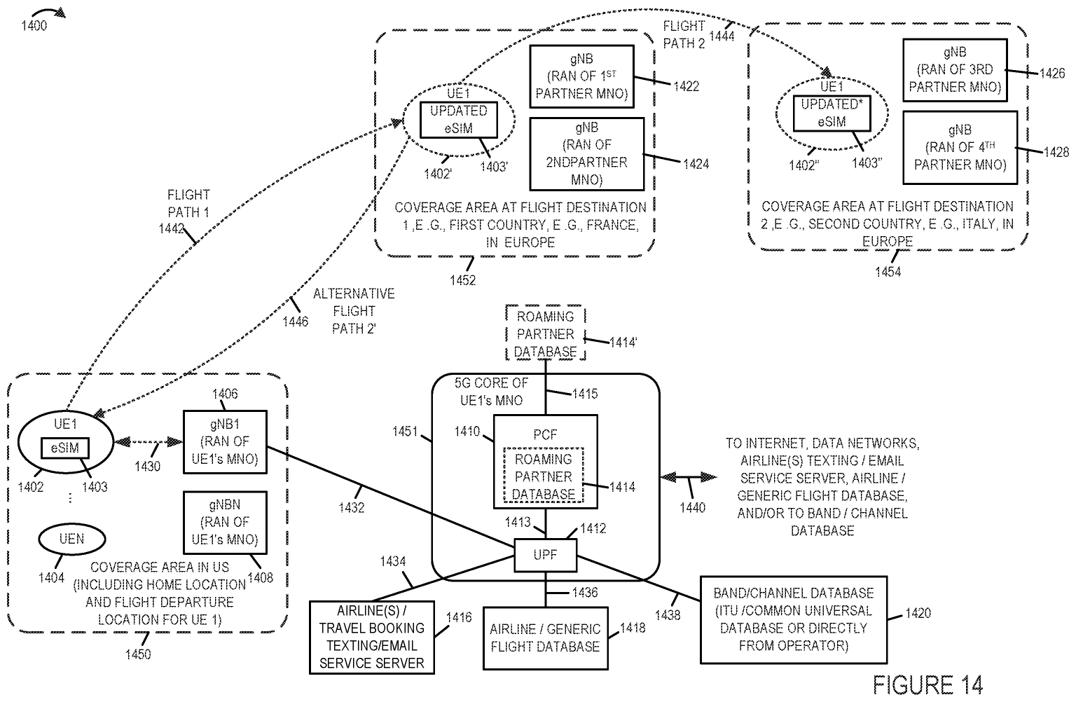

FIG. 6, comprising the combination of FIG. 6A and FIG. 6B, is a flowchart 600 of an exemplary method of operating a communications device, e.g. a user equipment (UE), in accordance with an exemplary embodiment. The UE implementing the method of flowchart 600 is, e.g., any of UE 10 of FIG. 1, the UE described with respect to FIG. 2, UE 302 of FIG. 3, UE 1 502 of FIG. 5, UE 700 of FIG. 7, a UE described with respect to any of FIGS. 8-13, or UE 1 1402 of FIG. 14. Operation starts in step 602, in which the communications device is powered on and initialized and proceeds to step 604.

In step 604 the communications device detects a text or email indicating planned travel to a first destination. In some embodiments, the detected text or email includes: a flight number, information indicating a departing airport, and information indicating a departure date and time. In some embodiments, the detected text or e-mail further includes information indicating a flight destination, e.g. information indicating a particular flight destination airport, with a known location in a city/country. Operation proceeds from step 604 to step 606. In step 606 the communications device determines, e.g., directly or indirectly, a travel destination from text included in the detected text or email, said travel destination being the first destination. Step 606 includes step 608 and/or step 610. In step 608 the communications device determines a flight, e.g., a flight number, or city airport, e.g., an arrival city airport, from the detected email. In step 610 the communications device accesses a database of airline flight information using the flight number included in the detected text or email, e.g., to determine the travel destination. Operation proceeds from step 606 to step 612.

In step 612 the communications device determines the time to retrieve roaming partner network information and/or a time to load a portion of memory in the communications device (e.g., load memory in an eSIM in the communications device and/or other load memory in the communications device) with roaming partner network information based on a determined time (day and/or time of day) of travel. Operation proceeds from step 612 to step 614.

In step 614 the communications device retrieves roaming partner network information (e.g., sends a request and gets responsive information) corresponding to the first destination. Step 614 includes step 616 and step 618. In step 616 the communications device accesses a roaming partner database, e.g. directly or via a policy control function (PCF), to identify roaming partner networks which are available at the determined destination. In step 618 the communications device receives, as part of roaming partner network information, partner network identifier information and frequency band information corresponding to each of the identified partner networks which are available at the determined destination. In some embodiments, the received roaming partner network information includes a list of networks, e.g., listed in order of network preference, which the communications device should try to attach to when starting up or after losing network connectivity. Operation proceeds from step 614 to step 620.

In step 620 the communications device loads a portion of memory in the communications device with roaming partner network information. The portion of memory in the communications device is, e.g., memory in an eSIM (Embedded Subscriber Identity Module) or other memory device, used to store information used in controlling network search and/or a list of networks, e.g., listed in order of network preference, which the communications device should try to attach to when starting up or after losing network connectivity. Operation proceeds from step 620 to step 622.

In step 622 the communications device detects arrival at the first destination, e.g., based on a communications device position fix, e.g., from a GPS receiver embedded in the communications device. Operation proceeds from step 622 to step 624. In step 624 the communications device, in response to detecting arrival at the first destination, uses the stored roaming partner network information to establish a connection with a roaming partner network. For example, the communications device, in step 624, uses the stored roaming partner network information to search for a roaming partner network, which is providing wireless access, in the order of roaming partner networks indicated in the stored roaming partner network information, previously pre-loaded in the eSIM, and/or sends a radio access request to roaming partner in a particular frequency band and/or particular channel identified in the roaming partner network information corresponding to the first destination to establish a connection with a roaming partner network, e.g., a preferred roaming partner network, at the first destination. Operation proceeds from step 624 to step 626. In step 626 the communications device uses the roaming partner network to obtain communications service while at the first destination. Operation proceeds from step 626, via connecting node A 628, to step 630.

In step 630 the communications device detects a second text or email indicating planned travel to a second destination. The second destination is, e.g., a new destination or the user's original home location at which the user's home network is used. Operation proceeds from step 630 to step 632.

In step 632 the communications device retrieves network information corresponding to the second destination, e.g. while still attached to the partner network at the first destination. The network information corresponding to the second destination may be roaming partner information, when the second destination is another destination outside the home network coverage area, or the network information corresponding to the second destination may be home network information, when the second destination is within the user's home network area, which is normally the case in the case of a return trip or flight. Operation proceeds from step 632 to step 634. In step 634 the communications device loads the portion of memory in the communications device (e.g., loads the memory in the eSIM on the communications device) with network information corresponding to the second destination prior to departure (e.g. on a flight) to the second destination. In some embodiments, when the second destination is the home destination, network information corresponding to the home network operator is already resident in the eSIM, and an operation is performed to reactive use of this home network operator information for the initial search. Operation proceeds from step 634 to step 636.

In step 636 the communications device deletes the roaming partner network information, stored in the portion of memory in the communications device (e.g., in the eSIM in the communications device) which corresponds to the partner network for the first destination, upon detecting arrival in the network coverage area corresponding to the second destination (e.g., network coverage area corresponding to the home communications network for the communications device (e.g., UE) or second location corresponding to a new location). Operation proceeds from step 636 to step 638.

In step 638 the communications device uses the network information corresponding to the second destination to obtain communications services while at the second destination.

FIG. 7 is a drawing of an exemplary user equipment (UE) 700 in accordance with an exemplary embodiment. Exemplary UE 700 is, e.g., any of UE 10 of FIG. 1, the UE described with respect to FIG. 2, UE 302 of FIG. 3, UE 1 502 of FIG. 5, or a UE implementing the method of flowchart 600 of FIG. 6, an UE described with respect to any of FIG. 2 8-13, and/or UE 1 1402 of system 1400 of FIG. 14. Exemplary UE 700 includes a processor 702, e.g., a CPU, wireless interfaces 704, a network interface 706, an I/O interface 708, an embedded SIM (eSIM) 709 including eSIM memory 713, a GPS receiver 710, memory 712, and an assembly of hardware components 714, e.g., an assembly of circuits, coupled together via a bus 716 over which the various elements may interchange data and information.

Wireless interfaces 708 includes one or more wireless interfaces (1st wireless interface 722, . . . , Nth wireless interface 736). For example, the 1st wireless interface 722 is a cellular wireless interface, and the Nth wireless interface 736 is a WiFi wireless interface. 1st wireless interface 722 includes a wireless receiver 724 coupled to one or more receive antennas or receive antenna elements (728, . . . , 730), via which the UE 700 may receive wireless signals. 1st wireless interface 722 includes a wireless transmitter 726 coupled to one or more transmit antennas or transmit antenna elements (732, . . . , 734), via which the UE 700 may transmit wireless signals. Nth wireless interface 736 includes a wireless receiver 738 coupled to one or more receive antennas or receive antenna elements (742, . . . , 744), via which the UE 700 may receive wireless signals. Nth wireless interface 736 includes a wireless transmitter 740 coupled to one or more transmit antennas or transmit antenna elements (746, . . . , 748), via which the UE 700 may transmit wireless signals. In some embodiments the same antennas or antenna elements are used for both receive and transmit. Different wireless interfaces included in wireless interfaces 704 may correspond to different technologies, different protocols, and/or different frequency bands.

Network interface 706, e.g., a wired or optical interface, includes a receiver 718, a transmitter 720 and connector 721. Network interface 706 may be, and sometimes is, used by UE 700 to communicate with other devices when the UE 700 is located at a premises in which a wireline connection is available.

UE 700 further includes a plurality of I/O devices (microphone 756, speaker 758, camera 760, display 762, switches 764, keypad 766, mouse 768), which are coupled to I/O interface 708. The I/O interface 708 couples the various I/O devices included in UE 700 to other elements within UE 700.

eSIM 709 includes eSIM memory 713 which includes UE subscriber information. The UE subscriber information includes network information, e.g., network ID information, frequency band information, channel information, frequency information, access information, etc., corresponding to the home network operator to which the user of UE 700 subscribes. In accordance with a feature of the present invention, network information corresponding to a roaming partner network, corresponding to a travel destination, may be, and sometimes is, retrieved and loaded into the eSIM prior to arrival at the travel destination, to facilitate efficient and rapid establishment of a connection between the UE 700 and a roaming partner network at the travel destination. In some embodiments, information indicating a prioritized search order corresponding to one or more alternative roaming networks and/or one or more alternative bands/channels is stored in eSIM memory 713.

GPS receiver 710 is coupled to GPS antenna 711, via which the UE 700 receives GPS signals. The GPS receiver 710 processes the received GPS signals to determine time, UE device position, e.g., latitude, longitude, and altitude, and UE velocity information. In some embodiments, the GPS receiver 710 also perform navigation functions based on processed received GPS signals and/or other received inputs, e.g., inertial measurement information from sensors, e.g., gyroscopes and/or accelerometers (e.g., in an IMU chip) included in UE 700. Thus, GPS receiver 710 can, and sometimes does, determine the present location of UE 700, e.g., the GPS receiver 710 determines when the UE 700 arrives at a travel destination or when the UE 700 is within a certain, e.g., predetermined range, of the travel destination.

Memory 712 includes control routine 770, an assembly of components 772, e.g., an assembly of software components, and data/information 776. In some embodiments, assembly of components 772 includes a travel/roaming update application (APP)/function 774.

Control routine 770 includes instructions which when executed by processor 702 control the 700 to implement basic operational functions, e.g., read memory, write to memory, control an interface, load a program, subroutine, or app, etc.

Assembly of components 772, e.g., an assembly of software components, e.g., routines, subroutines, applications, modules, functions, etc., includes, e.g., code, e.g., machine executable instructions, which when executed by processor 702, controls the UE 700 to implement steps of a method, e.g., steps of the method of signaling diagram 500 of FIG. 5 which are performed by UE 502, steps of the method of flowchart 600 of FIG. 6, and/or steps of an exemplary method in any of the Figures which are performed by a UE. In some embodiments, the travel/roaming update application (APP)/function 774 includes, e.g., code, e.g., machine executable instructions, which when executed by processor 702, controls the UE 700 to implement steps of a method, e.g., steps of the method of signaling diagram 500 of FIG. 5 which are performed by UE 502, steps of the method of flowchart 600 of FIG. 6, and/or steps of an exemplary method in any of the Figures which are performed by a UE.

Data/information 776 includes a list 778 of phone numbers corresponding to airlines/travel booking services, a list of e-mail addresses 780 corresponding to airlines/travel booking services. Data/information 776 further includes a received text message 782 and/or a received e-mail 784 including flight information, a UE determined flight number and departure date/time 786, e.g., extracted by the UE from the received text message 782 or received email 784. Data/information 776 further includes a generated database query 788, e.g., to be sent to an airline/generic flight database, said query 788 including information identifying the flight, e.g. the flight number, said query requesting an arrival date/time and destination, and a received query response 788, e.g., from the airline/generic flight database, said query response including the flight destination and the flight arrival date and time.

Data/information 776 further includes a generated roaming partners information request 792, e.g., to be sent to the PCF of the 5G core of the mobile network operator to which the UE owner subscribes, said generated roaming partners request requesting a list of one or more roaming partner network operators which have access network(s) providing wireless coverage at the destination location, and requesting roaming partner network information including network ID information and channel information, e.g., frequency band information, channel number information, carrier frequency setting information, access information, etc., corresponding to channels available by the partner mobile network operator(s) network(s) at the destination. Data/information 776 further includes a generated roaming partners information request response, e.g., from the PCF, said response including roaming partner network information to be able to obtain communications services at the destination, said roaming partner network information including channel information for UE upgrade, e.g., eSIM upgrade, said response including in some embodiments, a prioritized list of available alternative roaming partner network(s) providing coverage at the destination with corresponding channel information, which may be used by the UE. Data/information 776 further includes a determined date/TOD 796 to push update information into the eSIM and/or into a function or memory device supplementing the eSIM, e.g. prior to the arrival at the destination. Data/information 776 further includes eSIM supplemental data storage 798. In some embodiments data/information 776 further includes a frequent traveler setting value 799, e.g., a value indicating a user selected setting which indicates enabled or disabled, which controls enablement of searching for flight information.

FIG. 8 is a drawing of an exemplary policy control function (PCF) device 800, e.g. a 5G core network node implementing a PCF, in accordance with an exemplary embodiment. Exemplary PCF device 800 is, e.g., PCF 316 of FIG. 3, PCF 508 of FIG. 5 or PCF 1410 of FIG. 14. PCF device 800 includes a processor 802, e.g., a CPU, a network interface 804, e.g., a wired or optical interface, and assembly of hardware components 810, e.g., an assembly of circuits, and memory 812 coupled together via a bus 814 over which the various elements may interchange data and information.

Network interface 804, e.g., a wired or optical interface, includes a receiver 806, a transmitter 808 and a connector 809. Memory 810 includes a control routine 816, an assembly of components 818, e.g., and assembly of software components, and data/information 820.

Control routine 816 includes instructions which when executed by processor 802 control the PCF device 800 to implement basic operational functions, e.g., read memory, write to memory, control an interface, load a program, subroutine, or app, etc. Assembly of components 818, e.g., an assembly of software components, e.g., routines, subroutines, applications, modules, functions, etc., includes, e.g., code, e.g., machine executable instructions, which when executed by processor 802, controls the PCF device 800 to implement steps of a method, e.g., steps of the method of signaling diagram 500 of FIG. 5 which are performed by PCF 506. Assembly of components 818 includes a UE roaming partners interface module 822, a roaming partners identification module 824, a roaming partners band/channel identification module 826 and a prioritization module 828. UE roaming partners interface module 824 interfaces with a UE, e.g. receiving and processing a roaming partners information request from a UE and generating and sending a roaming partners information request response to the UE. Roaming partners identification module 824 identifies one or more roaming partner operator networks which can be used by the UE at a destination, e.g., a destination included in a received roaming partners information request from the UE. In some embodiments, the roaming partners identification module 824 accesses and uses information in roaming partner database 830 included in memory 812 of PCF device 800. In other embodiments, the roaming partner database is external to PCF device 800 and the roaming partners identification module 824 generates and sends a request including a location of interest (destination location) to the externally located roaming partner database and receives a response from roaming partner database. Roaming partners band/channel identification module 826 sends a request, said request corresponding to a location of interest (e.g., travel destination location) and corresponding to one or more identified partner mobile network operators, which were identified as having spectrum at the location of interest and having an access network proving wireless coverage at the location of interest, to a band/channel database, said request requesting channel related information for channels which may be used by the UE at the location (destination), e.g., frequency band ID information, channel ID information specifying one or more available channels, information indicating preferred channels to be used, carrier frequency setting information, network ID information, and access related information, e.g., access configuration information. Roaming partners band/channel identification module 826 receives and processes responses from the band/channel database. Prioritization module 828 prioritizes the alternative available roaming partner networks, alternative available communications bands, and/or alternative available channels which are available to be used by the UE at the location of interest (travel destination), e.g., generating an ordered search list to be used by the UE when trying to attach to an access network at the location of interest (travel destination).

Data/information 820 includes, in some embodiments, roaming partner database 824. In other embodiments, the roaming partner database is external to the PCF device 800 but is accessible to, and sometimes coupled to, the PCF 800. Data/information 820 further includes a received roaming partner information request 832 from a UE, a generated channels information request 838 to be sent to a band/channel database, a received channel information request response 838 from the band/channel database, a determined (prioritized) list of channels 842 for the UE to scan. and a generated roaming partner information request response 844 to be sent to the UE, said request response including information, e.g., roaming partner network information, intended to stored in the UE and pushed by the UE into its eSIM prior to arrival at the destination, to be used for efficient and rapid connection establishment by the UE with an access network of a roaming partner network operator at the destination.

In some embodiments, e.g., an embodiment in which the roaming partner database is located external to the PCF device 800, data/information 820 further includes a generated roaming partners information request to be sent to the roaming partner database and a received roaming partners information response 836 from the roaming partner database.

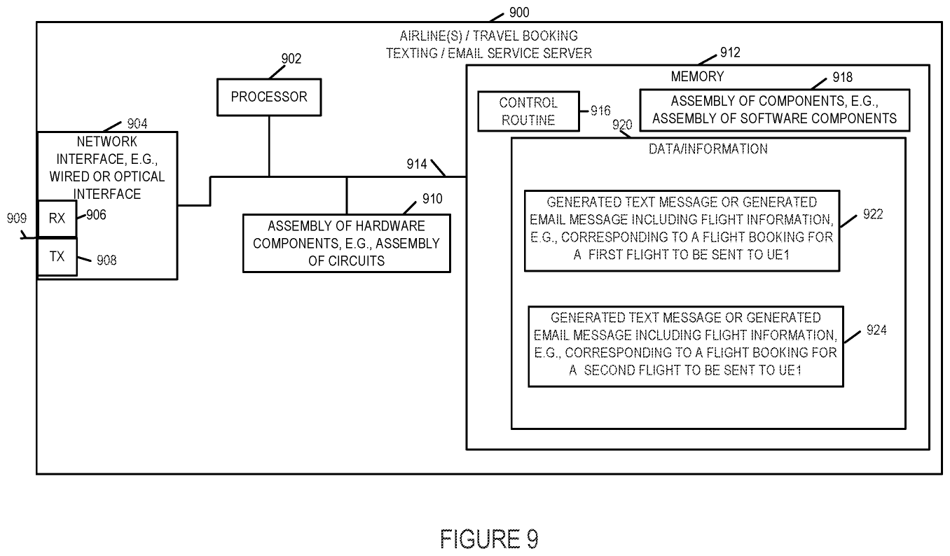

FIG. 9 is a drawing of an exemplary airline(s)/travel booking texting/email service server 900. Exemplary airline(s)/travel booking texting/email service server 900 is, e.g., airline(s)/travel booking texting/email service server 504 of FIG. 5 or airline(s)/travel booking texting/e-mail service server 1416 of FIG. 14. Server 900 includes a processor 902, e.g., a CPU, a network interface 904, e.g., a wired or optical interface, and assembly of hardware components 910, e.g., an assembly of circuits, and memory 912 coupled together via a bus 914 over which the various elements may interchange data and information.

Network interface 904, e.g., a wired or optical interface, includes a receiver 906, a transmitter 908 and a connector 909. Memory 912 includes a control routine 916, an assembly of components 918, e.g., an assembly of software components, and data/information 920.

Control routine 916 includes instructions which when executed by processor 902 control the server 900 to implement basic operational functions, e.g., read memory, write to memory, control an interface, load a program, subroutine, or app, etc. Assembly of components 918, e.g., an assembly of software components, e.g., routines, subroutines, applications, etc., includes, e.g., code, e.g., machine executable instructions, which when executed by processor 902, controls the server 900 to implement steps of a method, e.g., steps of the method of signaling diagram 500 of FIG. 5 which are performed by airline(s)/travel booking texting/email service server 504.

Data/information 920 includes a generated text message or generated email message including flight information 922, e.g., a flight booking confirmation message including a flight number and a departure date/time corresponding to a first flight to be sent to a UE, which is expected to be on the booked flight and which will need to establish a wireless connection with a roaming partner access network at the travel first destination, e.g. in a different country, and a generated text message or generated email message including flight information 924, e.g., a flight booking confirmation message including a flight number and a departure date/time corresponding to a second flight to be sent to a UE, which is expected to be on the booked flight to the second destination and which will need to establish a wireless connection with an access network at the second destination, e.g., another roaming partner network or the UEs home network (in the case of a return trip from the first destination).

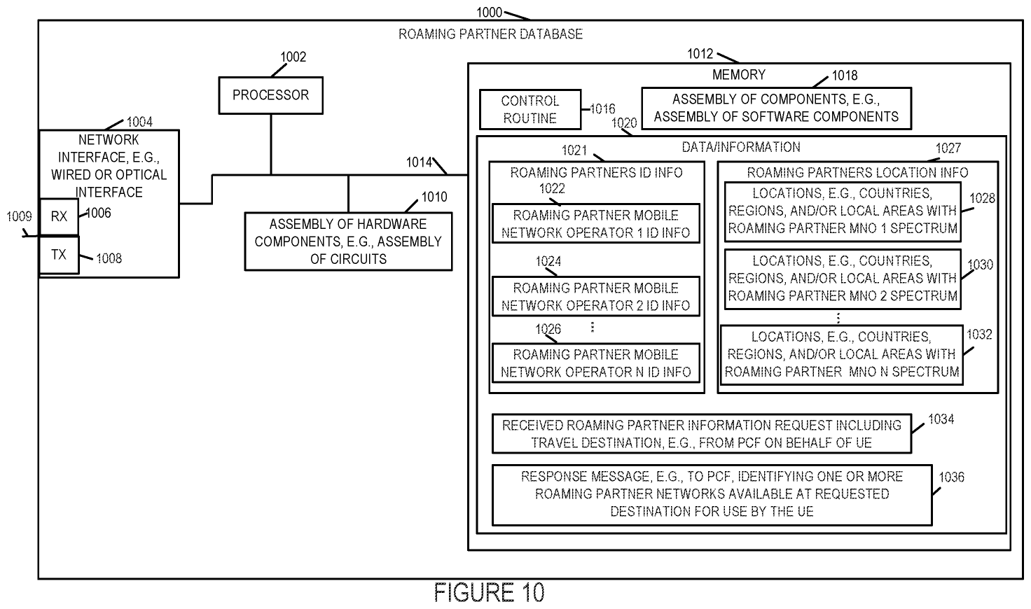

FIG. 10 is a drawing of an exemplary roaming partner database 1000. Exemplary roaming partner database 1000 is coupled to a PCF or included as part of a PCF. Roaming partner network database is, e.g., any of a roaming partner network database of FIG. 4, roaming partner network database 1414 of FIG. 14, or roaming partner network database 1414′ of FIG. 14. Roaming partner database 1000 includes a processor 1002, e.g., a CPU, a network interface 1004, e.g., a wired or optical interface, and assembly of hardware components 1010, e.g., an assembly of circuits, and memory 1012 coupled together via a bus 1014 over which the various elements may interchange data and information.

Network interface 1004, e.g., a wired or optical interface, includes a receiver 1006, a transmitter 1008 and a connector 1009. Memory 1010 includes a control routine 1016, an assembly of components 1018, e.g., an assembly of software components, and data/information 1020.

Control routine 1016 includes instructions which when executed by processor 1002 control the roaming partner database 1000 to implement basic operational functions, e.g., read memory, write to memory, control an interface, load a program, subroutine, or app, etc. Assembly of components 1018, e.g., an assembly of software components, e.g., routines, subroutines, applications, etc., includes, e.g., code, e.g., machine executable instructions, which when executed by processor 1002, controls the roaming partner database 10000 to implement steps of a method, e.g., steps of the method of signaling diagram 500 of FIG. 5 which are performed by PCF/roaming partner database 508.

Data/information 1020 includes information 1021 identifying a plurality of roaming partner mobile network operators, e.g. wireless carriers with spectrum, which have spectrum sharing partnership agreements with the MNO, to which the traveler with UE is a subscriber. Roaming partner ID information 1021 includes roaming partner mobile network operator 1 ID information 1022, roaming partner mobile network operator 2 ID information 1024, and roaming partner mobile network operator N ID information 1026. Data/information 1020 further includes roaming partners location information 1027. Roaming partners locations information 1027 includes information 1028 identifying locations, e.g. countries, regions, and/or local areas with roaming partner MNO 1 spectrum, information 1030 identifying locations, e.g. countries, regions, and/or local areas with roaming partner MNO 2 spectrum, and information 1032 identifying locations, e.g. countries, regions, and/or local areas with roaming partner MNO N spectrum.

Data/information 1020 further includes a received roaming partner information request 1034 including a travel destination, e.g. from a PCF on behalf of a UE, and a generated response message 1036, e.g., to be sent to the PCF, said response message identifying one or more partner network which are available to be used by the UE at the requested travel destination.

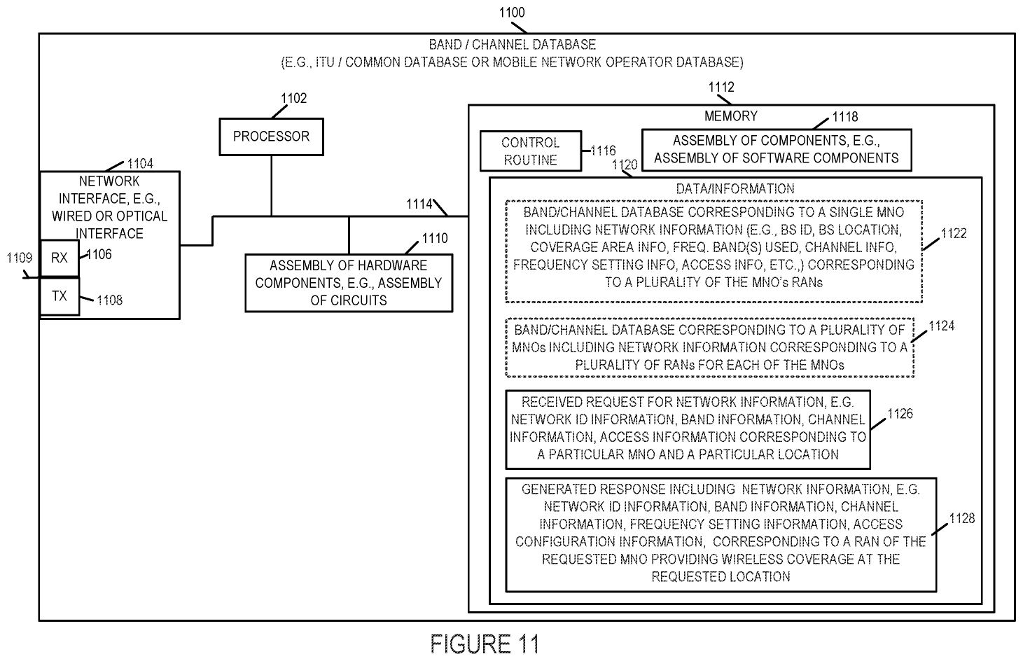

FIG. 11 is a drawing of an exemplary band/channel database 1100, e.g., a ITU/common database or a mobile network operator database. Exemplary band/channel database 1100 is, e.g., band/channel database 510 of FIG. 5 or the band/channel database 1420 of FIG. 14. Band/channel database 1100 includes a processor 1102, e.g., a CPU, a network interface 1104, e.g., a wired or optical interface, and assembly of hardware components 1110, e.g., an assembly of circuits, and memory 1112 coupled together via a bus 1114 over which the various elements may interchange data and information.

Network interface 1104, e.g., a wired or optical interface, includes a receiver 1106, a transmitter 1108 and a connector 1109. Memory 1112 includes a control routine 1116, an assembly of components 1118, e.g., an assembly of software components, and data/information 1120.

Control routine 1116 includes instructions which when executed by processor 1102 control the roaming partner database 1100 to implement basic operational functions, e.g., read memory, write to memory, control an interface, load a program, subroutine, or app, etc. Assembly of components 1118, e.g., an assembly of software components, e.g., routines, subroutines, applications, etc., includes, e.g., code, e.g., machine executable instructions, which when executed by processor 1102, controls the band/channel database 1100 to implement steps of a method, e.g., steps of the method of signaling diagram 500 of FIG. 5 which are performed by band/channel database 510.

Data/information 1120 includes a band/channel database 1122 corresponding to a single MNO or a band/channel database 1124 corresponding to a plurality of MNOs. Band/channel database 1122 corresponding to a single MNO includes network information, e.g., base station ID information, BS location information, BS wireless coverage area information, information identifying frequency band(s) used by the BS, channel information, frequency setting information for the BS, access information for obtaining access from the BS, etc., corresponding to a plurality of the MNOs RANs. A different set of network information may correspond in each of the MNOs RANs. Band/channel database 1124 corresponding to a plurality of MNOs includes network information corresponding to a plurality of RANs for each of the MNOs. Data/information 1120 further includes a received request 1126 (e.g., channels request 542 of FIG. 5) for network information, e.g. network ID information, band information, channel information, access information, frequency setting information, corresponding to a particular MNO and a particular location. Data/information 1120 further includes a generated response 1128 (e.g., channels information 548 of FIG. 5) including network information, e.g., network ID information, band information, channel information, frequency setting information, access configuration information, etc., corresponding toa RAN of the requested MNO which is providing wireless coverage at the requested location. In some embodiments, the request for network information, e.g., request 1126, includes information identifying a particular RAN for which the network information is being requested.

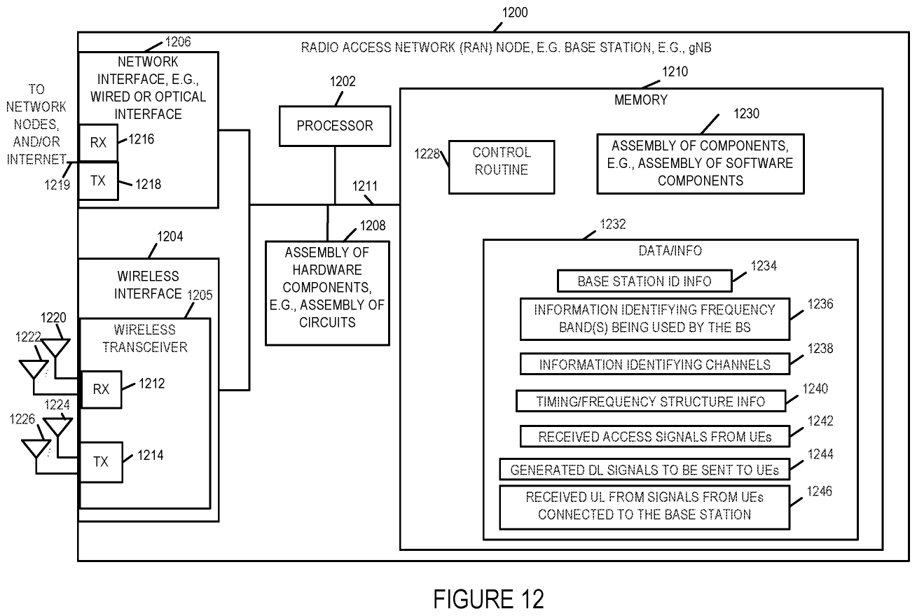

FIG. 12 is a drawing of an exemplary radio access network (RAN) node 1200, e.g. base station, e.g., a gNB, in accordance with an exemplary embodiment. Exemplary access network node 1200 is RAN 304 of FIG. 3, or any of the gNBs (1406, 1408, 1422, 1424, 1426, 1428) of system 1400 of FIG. 14. Exemplary radio access network node 1200 includes a processor 1202, e.g., a CPU, wireless interface 1204, a network interface 1206, an assembly of hardware components 1208, e.g., an assembly of circuits, and memory 1210 coupled together via a bus 1211 over which the various elements may interchange data and information.

Wireless interface 1204 includes a wireless receiver 1212 coupled to one or more receive antennas or receive antenna elements (1220, . . . , 1222), via which the access network node 1200 may receive wireless signals, e.g., from UEs. Wireless interface 1204 further includes a wireless transmitter 1214 coupled to one or more transmit antennas or transmit antenna elements (1224, . . . , 1226), via which the access network node 1200 may transmit wireless signals, e.g., to UEs.

Network interface 1206, e.g., a wired or optical interface, includes a receiver 1216, a transmitter 1218 and connector 1219. Network interface 1206 couples the access network node 1200 to a core network including core network nodes, e.g., a node implementing a PCF, a node implementing an AMF, a node implementing a SMF, nodes implementing UPFs, a node implementing a PSA UPF, etc., to other access network nodes, and/or to the Internet. Memory 1210 includes control routine 1228, an assembly of components 1230, e.g., an assembly of software components, and data/information 1232. Control routine 1228 includes instructions which when executed by processor 1202 control the radio access network node 1200 to implement basic operational functions, e.g., read memory, write to memory, control an interface, load a program, subroutine, or app, etc. Assembly of components 1230, e.g., an assembly of software components, e.g., routines, subroutines, applications, etc., includes, e.g., code, e.g., machine executable instructions, which when executed by processor 1202, controls the radio access network node 1200 to implement steps of a method. Data/information 1232 includes base station ID information 1234, information 1236, identifying frequency bands used by the base station, information 1238 identifying channels used by the base station, timing/frequency structure information 1240, received access signals 1242 from UEs, generated DL signals 1244 including DL control and DL traffic signals to be sent to UEs, and received UL signals 1246 including UL control and UL traffic signals from UEs connected to the base station.

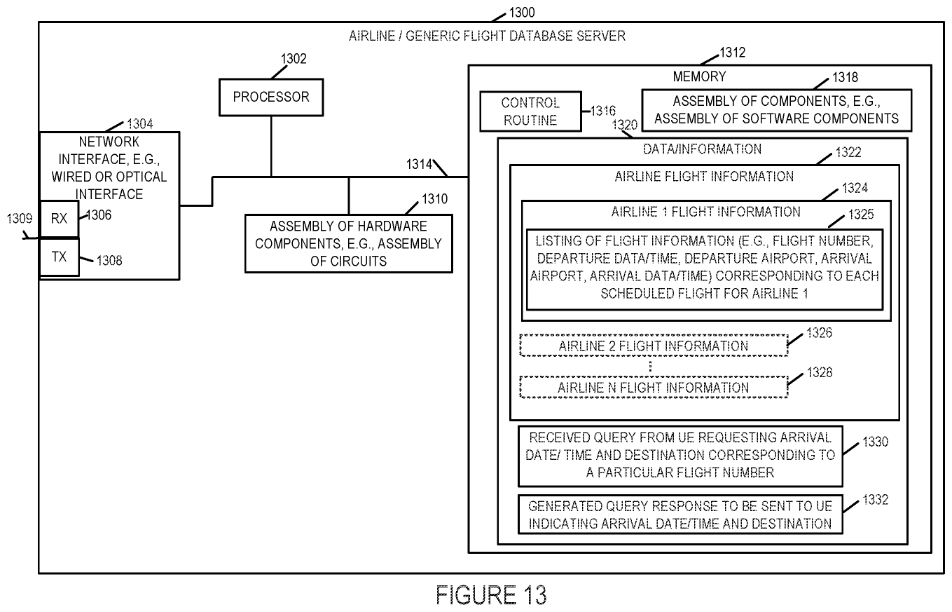

FIG. 13 is a drawing of an exemplary airline/generic flight database server 1300. Exemplary airline/generic flight database server 1300 is, e.g., airline/generic flight database 506 of FIG. 5 or airline/generic flight database 1418 of FIG. 14. Server 1300 includes a processor 1302, e.g., a CPU, a network interface 1304, e.g., a wired or optical interface, and assembly of hardware components 1310, e.g., an assembly of circuits, and memory 1312 coupled together via a bus 1314 over which the various elements may interchange data and information.

Network interface 1304, e.g., a wired or optical interface, includes a receiver 1306, a transmitter 1308 and a connector 1309. Memory 1312 includes a control routine 1316, an assembly of components 1318, e.g., an assembly of software components, and data/information 1320.

Control routine 1316 includes instructions which when executed by processor 1302 control the server 1300 to implement basic operational functions, e.g., read memory, write to memory, control an interface, load a program, subroutine, or app, etc. Assembly of components 1318, e.g., an assembly of software components, e.g., routines, subroutines, applications, etc., includes, e.g., code, e.g., machine executable instructions, which when executed by processor 1302, controls the server 1300 to implement steps of a method, e.g., steps of the method of signaling diagram 500 of FIG. 5 which are performed by airline/generic flight database 506.

Data/information 1320 includes airline flight information 1322. In an embodiment in which flight database 1300 is an airline flight database, airline flight information 1322 includes airline 1 flight information 1324 which includes an accessible list of flight information 1325 (e.g., flight number, departure date/time, departure airport, arrival airport, arrival date/time) corresponding to each flight for airline 1. In an embodiment in which flight database 1300 is a generic flight database, airline flight information 1322 includes accessible airline flight information corresponding to a plurality of different airlines (airline 1 flight information 1324, airline 2 flight information 1326, . . . , airline N flight information 1328).

Data/information 1320 further includes a received query 1330 from a UE requesting arrival date/time and destination corresponding to a particular flight number, and a generated query response 1332 to be sent to the UE, said query response indicating arrival date/time and destination corresponding to the flight number in the query.

FIG. 14 is a drawing of an exemplary communications system 1400 in accordance with an exemplary embodiment. Exemplary communications system 1400 includes a plurality of UEs (UE 1 1402 including eSIM 1403, . . . , UE N 1404 which also includes an eSIM), gNB1 1406, which is a RAN of UE1's MNO, and gNB N 1408, which is another RAN of UE1's MNO. The base stations, gNB1 1406 and gNBN 1408, are both located within a wireless coverage area 1450 in the US, said wireless coverage area 1450 including the home location and flight departure area for UE1 1402, said wireless coverage area 1450 corresponding to the MNO to which the user of UE1 1402 subscribes. Communications system 1400 further includes a 5G core network 1451 of UE1's MNO. 5G core network 1451 includes PCF 1410 and UPF 1412. In some embodiments, PCF 1410 includes a roaming partner database 1414. In other embodiments, PCF 1410 is coupled, e.g., via connection 1415, to a roaming partner database 1414′, which is external to the 5G core 1451.

Communications system 1400 further includes an airline(s)/travel booking texting/e-mail service server 1416, an airline/generic flight database 1418, and a band/channel database 1420, e.g., an ITU/common universal database or a band/channel database corresponding to a specific operator (wireless carrier which has spectrum), e.g. specific MNO which is a partner network with UE1's MNO.

gNB1 1406 is coupled to UPF 1412 via interface connection 1432. Airline(s)/travel booking texting/email service server 1416 is coupled to UPF 1412 via connection 1434. Initially, UE 1 1402 is coupled to gNB1 1406 via wireless connection 1430. UE 1402 can be, and sometimes is, coupled to airline(s)/travel booking texting/email service server 1416, via wireless connection 1430, gNB1 1406, connection 1432, UPF 1412 and connection 1434. Airline/generic flight database 1418 can be, and sometimes is, coupled to PCF 1410 via connection 1436, UPF 1412 and connection 1413. Band/channel database 1420 can be, and sometimes is, coupled to PCF 1410 via connection 1438, UPF 1412 and connection 1413. The 5CG core network 1451 can be coupled to the Internet, data network, airline(s)/travel booking texting/email service servers, airline/generic flight databases, and/or to band/channel databases via connection 1440.

Exemplary communications system 1400 further includes access networks (gNB 1422, gNB 1424) providing wireless coverage at flight destination 1, e.g., a particular area within a first country, e.g., France, in Europe. gNB 1422 is a RAN of 1st partner MNO. gNB 1424 is a RAN of a 2nd partner MNO.

Exemplary communications system 1400 further includes access networks (gNB 1426, gNB 1428) providing wireless coverage at flight destination 2, e.g., a particular area within a second country, e.g., Spain, in Europe. gNB 1426 is a RAN of 3rd partner MNO. gNB 1428 is a RAN of a 4th partner MNO.

Consider that the owner of UE1 1402 books a flight with flight path 1 1422. UE 1 1402 monitors for flight booking confirmation text messages and/or e-mail flight booking confirmation messages corresponding a set of phone numbers associated with airlines and/or travel booking services and/or a set of e-mail addresses associated with airlines and/or travel booking services, e.g., text messages and/or e-mails sent from airline(s) texting/email service server 1416 to UE 1402. Consider that the monitoring detects a travel booking confirmation including a flight number and a departure date and time. UE1 1402 sends a query including the flight number, to airline/generic flight database 1418, to obtain the flight destination and flight arrival date/time. UE1 1402 sends a roaming information request including the destination to PCF 1410. PCF 1410 uses the determined flight destination to query roaming partner database 1414 or roaming partner database 1414′ and identify one or more roaming partner networks, which have access networks providing wireless coverage at the destination and which can possibly be utilized by UE 1 1402. PCF 1410, having identified one or more roaming partner networks with coverage at the flight destination, then sends one or more requests to one or more band/channel databases, e.g., band/channel database 1420 to identify frequency bands, particular available channels within a frequency band, carrier frequency setting information, and roaming network information, e.g. information used to identify a particular access network and obtain wireless connection with the access network, for each of the potential one or more roaming partner networks which have been identified. Different roaming partner networks may have access networks using different communications bands, different communications protocols, etc., and some may be compatible with the capabilities of UE 1 1402, while others may not be. The PCF 1410 also priorities the received roaming network information, e.g., creating an ordered search list for the UE to use when trying to establish a wireless connection at the destination. PCF 1410 sends a response message to UE 1 1402, in response to the roaming information request, said response including roaming network information which can be used to update the eSIM 1403 prior to arrival at the destination, to facilitate a rapid efficient search for a suitable roaming partner network at the flight destination. UE1 1402 updates its eSIM 1403 prior to arrival at the flight path 1 destination, e.g. updates its eSIM 1403 just prior to departure.

UE 1 1402 is flown along flight path 1 1442 and arrives at destination 1 and is depicted as UE 1402′ with updated eSIM 1403′. UE 1 1402′ quickly acquires a wireless connection with one of the alternative available partner MNO gNB (1422 or 1424), e.g. using the information in updated eSIM 1403′.

The owner of UE 1 1402′ may book a flight along flight path 2 1444 to a new location, e.g., flight destination 2, or the owner of UE 1 1402′ may book a return flight along alternative flight path 2′ 1446.

When a flight is booked for flight path 2 1444 a similar process to the one described for destination 1 is performed. UE 1 1402′ monitors for flight booking confirmation text messages and/or e-mail flight booking confirmation messages corresponding a set of phone numbers associated with airlines and/or travel booking services and/or a set of e-mail addresses associated with airlines and/or travel booking services, e.g., text messages and/or e-mails sent from airline(s)/travel booking texting/email service server 1416 to UE 1402′. Consider that the monitoring detects a travel booking confirmation including a flight number and a departure date and time. UE1 1402′ sends a query including the flight number, to airline/generic flight database 1418, to obtain the flight destination and flight arrival date/time. UE1 1402′ sends a roaming information request including the destination to PCF 1410. PCF 1410 uses the determined flight destination (destination 2) to query roaming partner database 1414 or roaming partner database 1414′ and identify one or more roaming partner networks, which have access networks providing wireless coverage at the destination and which can possibly be utilized by UE 1 1402′. PCF 1410, having identified one or more roaming partner networks with coverage at the flight destination (destination 2), then sends one or more requests to one or more band/channel databases, e.g., band/channel database 1420 to identify frequency bands, particular available channels within a frequency band, carrier frequency setting information, and roaming network information, e.g. information used to identify a particular access network and obtain wireless connection with the access network, for each of the potential one or more roaming partner network which have been identified. Different roaming partner networks may have access networks using different communications bands, different communications protocols, etc., and some may be compatible with the capabilities of UE 1 1402, while others may not be. The PCF 1410 also priorities the received roaming network information, e.g., creating an ordered search list for the UE to use when trying to establish a wireless connection at the destination. PCF 1410 sends a response message to UE 1 1402′, in response to the roaming information request, said response including roaming network information which can be used to update the eSIM 1403′ prior to arrival at destination 2, to facilitate a rapid efficient search for a suitable roaming partner network at the flight destination. UE1 1402′ updates its eSIM prior 1403′ to arrival at the flight path 2 destination, e.g. updates its eSIM 1403′ just prior to departure.

UE 1 1402′ is flown along flight path 2 1444 and arrives at destination 2 and is depicted as UE 1402″ with updated eSIM 1403″. UE 1 1402″ quickly acquires a wireless connection with one of the alternative available partner MNO gNB (1426 or 1428), e.g. using the information in updated eSIM 1403″.

It should be appreciated that the detection of the booking confirmation message corresponding to the flight along flight path 2 1444, the identification of flight destination 2, the identification of suitable available roaming partner networks at destination 2, and the communications of roaming partner network information for destination 2 including band/channel information to UE 1 may be, and sometimes is, performed, before the flight along flight path 1 1442. For example, consider that the owner of UE 1 books both flight path 1 1442 and flight path 2 1444 prior to departure from the home airport.

In such a case information is determined and stored in the UE 1 1402 as to when (date and time) to update the eSIM for each particular set of information corresponding to each particular destination, e.g., information is stored indicating that a first set of information is to be pushed into the eSIM just prior to departure from the home airport, and information is stored indicating that a second set of information is to pushed into the eSIM just prior to departure from destination 1 for the flight along flight path 2 1444.

Now consider the example, in which owner of UE 1 1402′ books a return flight along alternative flight path 2′ 1446. In this case the UE 1 1402′ is controlled to update eSIM 1403′ to its original configuration, represented by eSIM 1403, for its home MNO, just prior to departure on alternative flight path 1446. When UE 1 1402 arrives back at its home network, it will be able to quickly establish a connection with gNB1 1406. In addition, when UE1 1402 arrives back at its home network, the UE 1402 can delete stored information corresponding to travel destination 1, e.g., stored roaming partner network information corresponding to flight destination 1.

Additional travel related applications, points, features and/or aspects, in accordance with some embodiments of the present invention, will now be described. Similarly, when a UE moves from one operator (MNO international or national) to another operator (HMNO), the UEs can be, and sometimes is, instructed to move on the HMNO's own infrastructure first on high priority by scanning HMNO's bands/channels first. For example, consider mobile subscribers, corresponding to a first HMNO operator which has CBRS spectrum, who have gone abroad and then have returned to the US, their mobiles will first scan the CBRS and then other bands.

Similarly, if the borders are being crossed by land, e.g. between the US and a neighbor country, e.g., Mexico or Canada, a mobile location based function or app in a UE, can be, and in some embodiments is, configured and used, to look at the destination of the vehicle and get, e.g., acquire configuration profile of the roaming partner corresponding to the destination.

In some embodiments, one or more settings are purged once the trip is over to free up the cache memory. This can be updated using the information on the return flight similar to the departure flight.

If the flight is towards the native mobile operator region, in some embodiments, the function or app in the UE will purge the information and default to the native operator.

Additionally, in some embodiments, a setting in the mobile (UE), e.g., called ‘frequent traveler’, can be, and sometimes is enabled, which will allow the mobile to actively look for flight information.

### Numbered List of Exemplary Method Embodiments

Method Embodiment 1. A method of operating a communications device (e.g. user equipment device (UE)), the method comprising: detecting (604) a text or email indicating planned travel to a first destination; determining (606) a travel destination from text included in the detected text or email, said travel destination being the first destination; retrieving (614) roaming partner network information (e.g. send request and get responsive information) corresponding to the first destination; and loading (620) a portion of memory in the communications device (e.g., load an eSIM (Embedded Subscriber Identity Module) or other memory device, used to store information used in controlling network search order and/or list of networks, e.g., listed in order of network preference, which the communications device should try to attach to when starting up or after losing network connectivity) with the roaming partner network information.
Method Embodiment 1A. The method of Method Embodiment 1, wherein said communications device includes an embedded SIM (eSIM).
Method Embodiment 2. The method of Method Embodiment 1, further comprising: detecting (622) arrival at the first destination; and in response to detecting arrival at the first destination, using (624) the stored roaming partner network information (e.g., search for a roaming partner in order of roaming partner networks indicated in stored roaming partner information and/or send radio access request to roaming partner in frequency band indicated in roaming partner information corresponding to the first destination) to establish a connection with a roaming partner network.
Method Embodiment 2A. The method of Method Embodiment 2, further comprising: using (626) the roaming partner network to obtain communication services while at the first destination.
Method Embodiment 3. The method of Method Embodiment 1, further comprising: determining (612) the time to retrieve the roaming partner network information or load the portion of memory in the communications device (e.g., load the eSIM) with roaming partner network information based on a determined time (day and/or time) of travel.
Method Embodiment 4. The method of Method Embodiment 1, wherein determining (606) a travel destination includes determining (608) a flight or city airport from the detected text or Email.
Method Embodiment 5. The method of Method Embodiment 4, wherein determining (706) a travel destination includes accessing (610) a database of airline flight information using a flight number included in the detected text or Email.
Method Embodiment 6. The method of Method Embodiment 5, wherein retrieving (614) roaming partner network information includes accessing (616) a roaming partner database to identify roaming partner networks which are available at the determined first destination.
Method Embodiment 7. The method of Method Embodiment 1, wherein retrieving (614) roaming partner network information includes receiving (618), as part of said roaming partner network information, partner network identifier information and frequency band information.
Method Embodiment 8. The method of Method Embodiment 1, further comprising: detecting (630) a second text or email indicating planned travel to a second destination (e.g., a new destination or the user's original home location at which the user's home network is used).
Method Embodiment 9. The method of Method Embodiment 8, further comprising: retrieving (632) network information corresponding to the second destination (while still attached to the partner network at the first destination, the network information corresponding to the second destination may be roaming partner network information, when the second destination is another destination outside the home network coverage area or the network information corresponding to the second destination may be home network information, when the second destination is within the user's home network coverage area, which is normally the case in the case of a return trip or flight); and loading (634) the portion of memory in the communications device (e.g., load the eSIM on the communications device) with network information corresponding to the second destination prior to departure (e.g., on a flight) to the second destination.
Method Embodiment 10. The method of Method Embodiment 9, further comprising: deleting (636) the roaming partner network information, stored in the portion of memory in the communications device (e.g., in the eSIM) and corresponding to the partner network for the first destination upon detecting arrival in the network coverage area corresponding to the second destination (e.g., network coverage area corresponding to home communications network for the communications device (e.g. UE) or second destination corresponding to a new location).
Method Embodiment 10A. The method of Method Embodiment 10 further comprising: using (638) the network information corresponding to the second destination to obtain communication services while at the second destination.

### Numbered List of Exemplary Apparatus Embodiments

Apparatus Embodiment 1. A communications device (e.g. user equipment device (UE)) (700) comprising: memory (memory 712 and/or eSIM memory 713); and a processor (702) configured to operate the communications device to: detect (604) a text or email indicating planned travel to a first destination; determine (606) a travel destination from text included in the detected text or email, said travel destination being the first destination; retrieve (614) roaming partner network information (e.g. send request and get responsive information) corresponding to the first destination; and load (620) a portion of memory in the communications device (e.g., load an eSIM (Embedded Subscriber Identity Module) or other memory device, used to store information used in controlling network search order and/or list of networks, e.g., listed in order of network preference, which the communications device should try to attach to when starting up or after losing network connectivity) with the roaming partner network information.
Apparatus Embodiment 1A. The communications device of Apparatus Embodiment 1, wherein said communications device includes an embedded SIM (eSIM).
Apparatus Embodiment 2. The communications device of Apparatus Embodiment 1, wherein said processor is further configured to operate the communications device to: detect (622) arrival at the first destination; and in response to detecting arrival at the first destination, use (624) the stored roaming partner network information (e.g., search for a roaming partner in order of roaming partner networks indicated in stored roaming partner information and/or send radio access request to roaming partner in frequency band indicated in roaming partner information corresponding to the first destination) to establish a connection with a roaming partner network.
Apparatus Embodiment 2A. The communications device of Apparatus Embodiment 2, wherein said processor is further configured to operate the communication device to: use (626) the roaming partner network to obtain communication services while at the first destination.
Apparatus Embodiment 3. The communications device of Apparatus Embodiment 1, wherein said processor is further configured to operate the communications device to: determine (612) the time to retrieve the roaming partner network information or load the portion of memory in the communications device (e.g., load the eSIM) with roaming partner network information based on a determined time (day and/or time) of travel.
Apparatus Embodiment 4. The communications device of Apparatus Embodiment 1, wherein said processor is configured to operate the communications device to: determine (608) a flight or city airport from the detected text or Email as part of being configured to operate the communications device to determine (606) a travel destination.
Apparatus Embodiment 5. The communications device of Apparatus Embodiment 4, wherein said processor is configured to operate the communications device to access (610) a database of airline flight information using a flight number included in the detected text or Email, as part of being configured to determine (706) a travel destination.
Apparatus Embodiment 6. The communications device of Apparatus Embodiment 5, wherein said processor is configured to operate the communications device to: access (616) a roaming partner database to identify roaming partner networks which are available at the determined first destination, as part of being configured to operate the communications device to retrieve (614) roaming partner network information.
Apparatus Embodiment 7. The communications device of Apparatus Embodiment 1, wherein said processor is configured to operate the communications device to: receive (618) said roaming partner network information, as part of operating the communications to retrieve (614) roaming partner network information, said received roaming partner network information including roaming partner network identifier information and frequency band information.
Apparatus Embodiment 8. The communications device of Apparatus Embodiment 1, wherein said processor is further configured to operate the communications device to: detect (630) a second text or email indicating planned travel to a second destination (e.g., a new destination or the user's original home location at which the user's home network is used).
Apparatus Embodiment 9. The communications device of Apparatus Embodiment 8, wherein said processor is further configured to operate the communications device to: retrieve (632) network information corresponding to the second destination (while still attached to the partner network at the first destination, the network information corresponding to the second destination may be roaming partner network information, when the second destination is another destination outside the home network coverage area or the network information corresponding to the second destination may be home network information, when the second destination is within the user's home network coverage area, which is normally the case in the case of a return trip or flight); and load (634) the portion of memory in the communications device (e.g., load the eSIM on the communications device) with network information corresponding to the second destination prior to departure (e.g., on a flight) to the second destination.
Apparatus Embodiment 10. The communications device of Apparatus Embodiment 9, wherein said processor is further configured to operate the communications device to: delete (636) the roaming partner network information, stored in the portion of memory in the communications device (e.g., in the eSIM) and corresponding to the partner network for the first destination upon detecting arrival in the network coverage area corresponding to the second destination (e.g., network coverage area corresponding to home communications network for the communications device (e.g. UE) or second destination corresponding to a new location).
Apparatus Embodiment 10A. The communications device of Apparatus Embodiment 10, wherein said processor is further configured to operate the communications device to: use (638) the network information corresponding to the second destination to obtain communication services while at the second destination.

### Numbered List of Exemplary Non-Transitory

### Computer Readable Medium Embodiments

Non-Transitory Computer Readable Medium Embodiment 1. A non-transitory computer readable medium (712) including machine executable instructions, which when executed by a processor (702) of a communications device (e.g., UE 700), cause the communications device (700) to perform the steps of: detecting (604) a text or email indicating planned travel to a first destination; determining (606) a travel destination from text included in the detected text or email, said travel destination being the first destination; retrieving (614) roaming partner network information (e.g. send request and get responsive information) corresponding to the first destination; and loading (620) a portion of memory in the communications device (e.g., load an eSIM (Embedded Subscriber Identity Module) or other memory device, used to store information used in controlling network search order and/or list of networks, e.g., listed in order of network preference, which the communications device should try to attach to when starting up or after losing network connectivity) with the roaming partner network information.

The techniques of various embodiments may be implemented using software, hardware and/or a combination of software and hardware. Various embodiments are directed to apparatus, e.g., user equipment (UE) devices, core network devices (e.g., PCF devices, AMF devices, SMF devices, UPF devices, etc.), databases (e.g., roaming partner databases, airline/generic flight databases, band/channel databases), servers (e.g., airline(s)/travel booking texting/e-mail service servers), access network devices (e.g., base stations such as gNBs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating user equipment (UE) devices, databases (e.g., roaming partner databases, airline/generic flight databases, band/channel databases), servers (e.g., airline(s)/travel booking texting/e-mail service servers), core network devices (e.g., PCF devices, AMF devices, SMF devices, UPF devices, etc.), access network devices, e.g., gNBs, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to a machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., user equipment (UE) devices, core network devices (e.g., PCF devices, AMF devices, SMF devices, UPF devices, etc.), databases (e.g., roaming partner databases, airline/generic flight databases, band/channel databases), servers (e.g., airline(s)/travel booking texting/e-mail service servers), access network devices, e.g. gNBs, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, databases, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., user (UE) devices, core network devices (e.g., PCF devices, AMF devices, SMF devices, UPF devices, etc.), databases (e.g., roaming partner databases, airline/generic flight databases, band/channel databases), servers (e.g., airline(s)/travel booking texting/e-mail service servers), access network devices, e.g. gNBs, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., a user equipment (UE) devices, core network devices (e.g., PCF devices, AMF devices, SMF devices, UPF devices, etc.), databases (e.g., roaming partner databases, airline/generic flight databases, band/channel databases), servers (e.g., airline(s)/travel booking texting/e-mail service servers), access network devices, e.g. gNBs, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, with a processor which includes a component corresponding to each of the steps of the various described methods performed by the device in which the processor is included. In some but not all embodiments a device, e.g., user equipment (UE) devices, core network devices (e.g., PCF devices, AMF devices, SMF devices, UPF devices, etc.), databases (e.g., roaming partner databases, airline/generic flight databases, band/channel databases), servers (e.g., airline(s)/travel booking texting/e-mail service servers), access network devices, e.g. gNBs, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., user (UE) devices, core network devices (e.g., PCF devices, AMF devices, SMF devices, UPF devices, etc.), databases (e.g., roaming partner databases, airline/generic flight databases, band/channel databases), servers (e.g., airline(s)/travel booking texting/e-mail service servers), access network devices, e.g. gNBs, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a user equipment (UE) device, core network device (e.g., PCF device, AMF device, SMF device, UPF device, etc.), database (e.g., roaming partner database2, airline/generic flight database2, band/channel database), servers (e.g., airline(s)/travel booking texting/e-mail service server), access network device, e.g. gNB, wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating a communications device (e.g. user equipment device (UE)), the method comprising:
detecting a text or email indicating planned travel to a first destination;
determining a travel destination from text included in the detected text or email, said travel destination being the first destination;
retrieving roaming partner network information corresponding to the first destination; and
loading a portion of memory in the communications device with the roaming partner network information.

2. The method of claim 1, further comprising:
detecting arrival at the first destination; and
in response to detecting arrival at the first destination, using the stored roaming partner network information to establish a connection with a roaming partner network.

3. The method of claim 1, further comprising:
determining the time to retrieve the roaming partner network information or load the portion of memory in the communications device with roaming partner network information based on a determined time of travel.

4. The method of claim 1, wherein determining a travel destination includes determining a flight or city airport from the detected text or Email.

5. The method of claim 4, wherein determining a travel destination includes accessing a database of airline flight information using a flight number included in the detected text or Email.

6. The method of claim 5, wherein retrieving roaming partner network information includes accessing a roaming partner database to identify roaming partner networks which are available at the determined first destination.

7. The method of claim 1, wherein retrieving roaming partner network information includes receiving, as part of said roaming partner network information, partner network identifier information and frequency band information.

8. The method of claim 1, further comprising:
detecting a second text or email indicating planned travel to a second destination.

9. The method of claim 8, further comprising:
retrieving network information corresponding to the second destination; and
loading the portion of memory in the communications device with network information corresponding to the second destination prior to departure to the second destination.

10. The method of claim 9, further comprising:
deleting the roaming partner network information, stored in the portion of memory in the communications device and corresponding to the partner network for the first destination upon detecting arrival in the network coverage area corresponding to the second destination.

11. A communications device comprising:
memory; and
a processor configured to operate the communications device to:
detect a text or email indicating planned travel to a first destination;
determine a travel destination from text included in the detected text or email, said travel destination being the first destination;
retrieve roaming partner network information corresponding to the first destination; and
load a portion of memory in the communications device with the roaming partner network information.

12. The communications device of claim 11, wherein said processor is further configured to operate the communications device to:
detect arrival at the first destination; and
in response to detecting arrival at the first destination, use the stored roaming partner network to establish a connection with a roaming partner network.

13. The communications device of claim 11, wherein said processor is further configured to operate the communications device to:
determine the time to retrieve the roaming partner network information or load the portion of memory in the communications device with roaming partner network information based on a determined time of travel.

14. The communications device of claim 11, wherein said processor is configured to operate the communications device to:
determine a flight or city airport from the detected text or Email as part of being configured to operate the communications device to determine a travel destination.

15. The communications device of claim 14, wherein said processor is configured to operate the communications device to access a database of airline flight information using a flight number included in the detected text or Email, as part of being configured to determine (706) a travel destination.

16. The communications device of claim 15, wherein said processor is configured to operate the communications device to:
access a roaming partner database to identify roaming partner networks which are available at the determined first destination, as part of being configured to operate the communications device to retrieve roaming partner network information.

17. The communications device of claim 11, wherein said processor is configured to operate the communications device to:
receive said roaming partner network information, as part of operating the communications to retrieve roaming partner network information, said received roaming partner network information including roaming partner network identifier information and frequency band information.

18. The communications device of claim 11, wherein said processor is further configured to operate the communications device to:
detect a second text or email indicating planned travel to a second destination.

19. The communications device of claim 18, wherein said processor is further configured to operate the communications device to:
retrieve network information corresponding to the second destination; and
load the portion of memory in the communications device with network information corresponding to the second destination prior to departure to the second destination.

20. A non-transitory computer readable medium including machine executable instructions, which when executed by a processor of a communications device, cause the communications device to perform the steps of:
detecting a text or email indicating planned travel to a first destination;
determining a travel destination from text included in the detected text or email, said travel destination being the first destination;
retrieving roaming partner network information corresponding to the first destination; and
loading a portion of memory in the communications device with the roaming partner network information.
